(19) United States
(12) Patent Application Publication
(10) Pub. No.: US 2008/0051155 A1
(43) Pub. Date: Feb. 28, 2008

(54) ATTACHABLE SPEAKER APPARATUS AND AUDIO REPRODUCING SYSTEM HAVING THE SAME

(76) Inventor: Yoo Jun LEE, Seoul (KR)

Correspondence Address: BACON & THOMAS, PLLC, 625 SLATERS LANE, FOURTH FLOOR, ALEXANDRIA, VA, 22314, US

(21) Appl. No.: 11/838,319

(22) Filed: Aug. 14, 2007

(30) Foreign Application Priority Data
Aug. 23, 2006 (KR) 10-2006-0079825

(51) Int. Cl. H04M 1/00

(52) U.S. Cl. 455/569.1

(57) ABSTRACT

A speaker apparatus includes a speaker, a connection plug detachably and electrically connected to an earphone jack of the portable terminal, an amplifying block for amplifying an audio signal to output the amplified audio signal through the speaker, a RF modulation block for modulating the audio signal into an RF signal, and a switching block for selectively switching the audio signal to either the amplifying block or the RF modulation block. The speaker further includes an antenna for receiving a wireless aerial radio signal. The received radio signal is provided through the connection plug to the portable terminal in order for processing thereof.

### FIELD OF THE INVENTION

The present invention relates to a speaker apparatus and an audio reproducing system having the same; and, more particularly, to an attachable speaker apparatus, which is detachably connect to a portable terminal for reproducing an audio signal and outputs the audio signal to the surrounding, and an audio reproducing system having the speaker apparatus.

### BACKGROUND OF THE INVENTION

In general, portable terminals, such as MP3 players offer music playback services through an earphone detachably connected to an earphone jack thereof. Typically, these portable terminals do not have internal speakers mounted therein so as not to affect miniaturization and weight of the terminals.

Therefore, users listen to music through the earphone by inserting it into the earphone jack of the portable terminal. Such a music listening method using the earphone has the merit of listening to desired music whenever and wherever without causing any discomfort (e.g., noise damage) to people around the users, while the problem of causing a severe physical disorder, such as deafness, is seriously suggested by the medical world and the like.

As one scheme for solving the above problem, an attachable speaker has been developed and used. The attachable speaker is detachably connected to an earphone jack of a portable terminal through a connection plug equipped therein and functions only as an external speaker outputting music or the like to the outside. Therefore, the users can listen to music being played from the portable terminal through the earphone in places where there are a lot of people around them, and can listen to music by connecting an attachable speaker to the portable terminals in places where only they are present or where there are only few people present.

However, the attachable speaker as set forth above has a limitation in satisfying various needs of users.

That is, in case of owning the attachable speaker as an auxiliary equipment of the portable terminal, if there are more various functions, for example, the function of wirelessly and remotely delivering an audio signal outputted from the portable terminal to a remote speaker system (such as a speaker of home A/V equipment, a speaker of a vehicle A/V equipment or the like) for spectacular listening to the music, as well as the function of the external speaker, the users can expand the use of the attachable speaker, thereby achieving service satisfaction. However, the conventional attachable speakers do not function as a remote radio transmission as is suggested above.

Especially, it is generalized that, the portable terminal, such as a MP3 player and the like, employs a radio reception function according to the recent trend of integrating more functions in one terminal. The portable terminal having such a radio reception function is typically designed such that an earphone line functions as an antenna of the radio.

Consequently, in a case where the conventional attachable speaker is used with a portable terminal, the reception sensitivity of the radio channel is greatly deteriorated due to the absence of a radio reception antenna when a radio channel is received by selecting a radio reception service.

### SUMMARY OF THE INVENTION

It is, therefore, a primary object of the present invention to provide an attachable speaker apparatus with the function of wireless transmission to a remote speaker system.

Another object of the present invention is to provide an attachable speaker apparatus with the high-sensitivity reception of a radio channel.

Still another object of the present invention is to provide an audio reproducing system having the attachable speaker apparatus.

In accordance with an aspect of the present invention, there is provided a speaker apparatus for use with a portable terminal having an audio reproducing capability, comprising:

a speaker;

a connection plug detachably and electrically connected to an earphone jack of the portable terminal;

an amplifying block for amplifying an audio signal to output the amplified audio signal through the speaker, the audio signal being delivered from the portable terminal through the connection plug connected to the earphone jack;

a RF modulation block for modulating the audio signal into an RF signal;

a switching block for selectively switching the audio signal to either the amplifying block or the RF modulation block.

In accordance with another aspect of the present invention, there is provided an audio reproducing system comprising:

a portable terminal having capabilities of audio reproduction and radio processing; and

an attachable speaker apparatus optionally being connected to the portable terminal to produce an audio signal originated from the portable terminal, wherein the attachable speaker apparatus comprises:

a speaker; a connection plug detachably and electrically connected to an earphone jack equipped in the portable terminal;

an amplifying block for amplifying the audio signal to generate an amplified audio signal through the speaker;

a RF modulation block for modulating the audio signal into an RF signal; and

a switching block for selectively relaying the audio signal to either the amplifying block or the RF modulation block.

### BRIEF DESCRIPTION OF THE DRAWINGS

The above and other objects and features of the present invention will become apparent from the following description of embodiments, given in conjunction with the accompanying drawings, in which:

FIG. 1 is an aligned perspective view illustrating the alignment state of an attachable speaker apparatus of the present invention just before being connected to an earphone jack of a portable terminal;

FIG. 2 shows a perspective view of an attachable speaker apparatus in accordance with the present invention; and

FIG. 3 illustrates a block diagram of an attachable speaker apparatus in accordance with the present invention.

### DETAILED DESCRIPTION OF THE EMBODIMENTS

Hereinafter, embodiments of the present invention will be described in detail with reference to the accompanying drawings.

As will be described below, an attachable speaker apparatus of the present invention can selectively perform an external speaker function and an audio wireless transmission function through a simple switching operation By embedding an audio modulating function, an audio signal outputted from a portable terminal can be converted into a wirelessly transmittable signal and be wirelessly transmitted to a speaker system at a remote place, thereby effectively satisfying various service needs of users.

Further, the attachable speaker apparatus of the present invention can realize the high-sensitivity reception of a desired radio broadcast when inserted into an earphone jack of a portable terminal by embedding an radio reception antenna therein.

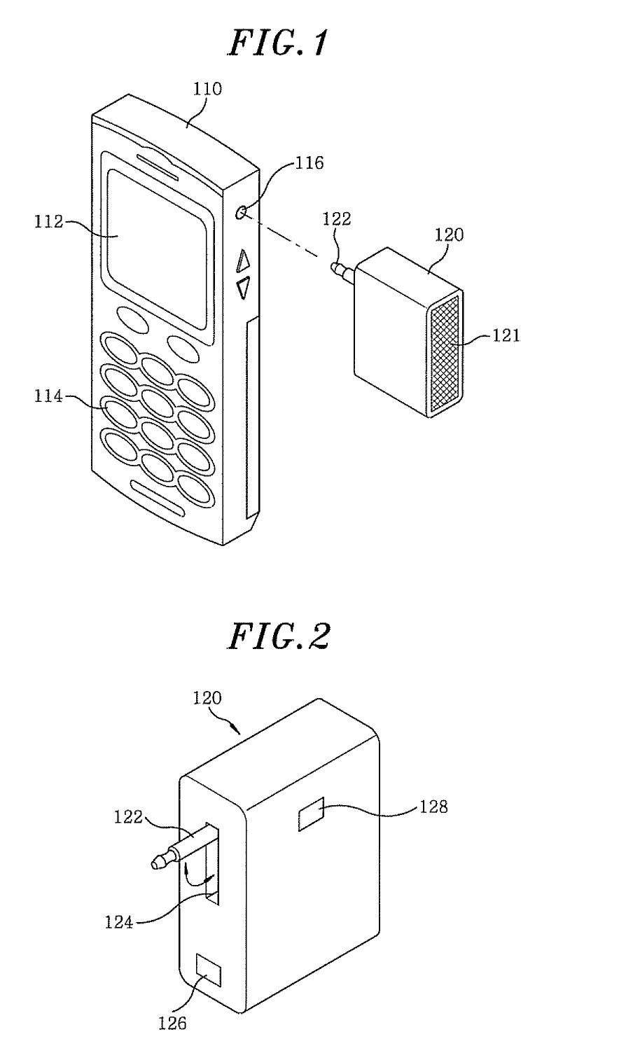

Referring now to FIG. 1, there is shown an aligned perspective view illustrating the alignment state of an attachable speaker apparatus of the present invention just before being connected to an earphone jack of a portable terminal, and FIG. 2 shows a perspective view of an attachable speaker apparatus in accordance with the present invention.

As shown in FIG. 1, a portable terminal 110 is provided with an earphone jack 116 into which a connection plug of an earphone (not shown) is detachably inserted. In the portable terminal 110, the earphone provides the function of outputting audio signal from the portable terminal 110 and the radio reception antenna function. Further, the portable terminal 110 includes a display panel 112, an operating panel 114 and so on. An attachable speaker apparatus 120 can be detachably mounted to the earphone jack 116 by inserting the connection plug 122 thereinto. In FIG. 1, unexplained reference numeral 121 denotes a speaker.

Therefore, users can receive listening services, such as music, by connecting the attachable speaker apparatus 120 to the portable terminal 110 while in a place where only they are present or in a place where there are only few people present. Here, the portable terminal 110 has the function of playing a music file such as an MP3 or outputting sound through a radio channel reception. This portable terminal 110 may be, for example, an MP3 player, a mobile phone such as a PCS or cellular phone, a PDA, a PMP, a DMB phone, a DMB receiver, and the like.

Further, the connection plug 122 employed in the attachable speaker apparatus 120 is, for example, a foldable connection plug that can be housed in a housing space 124 (that is, a housing space formed at one outer surface of the speaker extended from a connection region of the connection plug) The housing space 124 has such a shape and size as to house the connection plug 122 therein, as illustrated in FIG. 2. In accordance with the present invention, the portability of the attachable speaker apparatus 120 can be increased by employing such foldable connection plug 122. In FIG. 2, unexplained reference numeral 126 denotes a USB port to which a USB cable (not shown) is connected, and unexplained reference numeral 128 designates a display such as an LED.

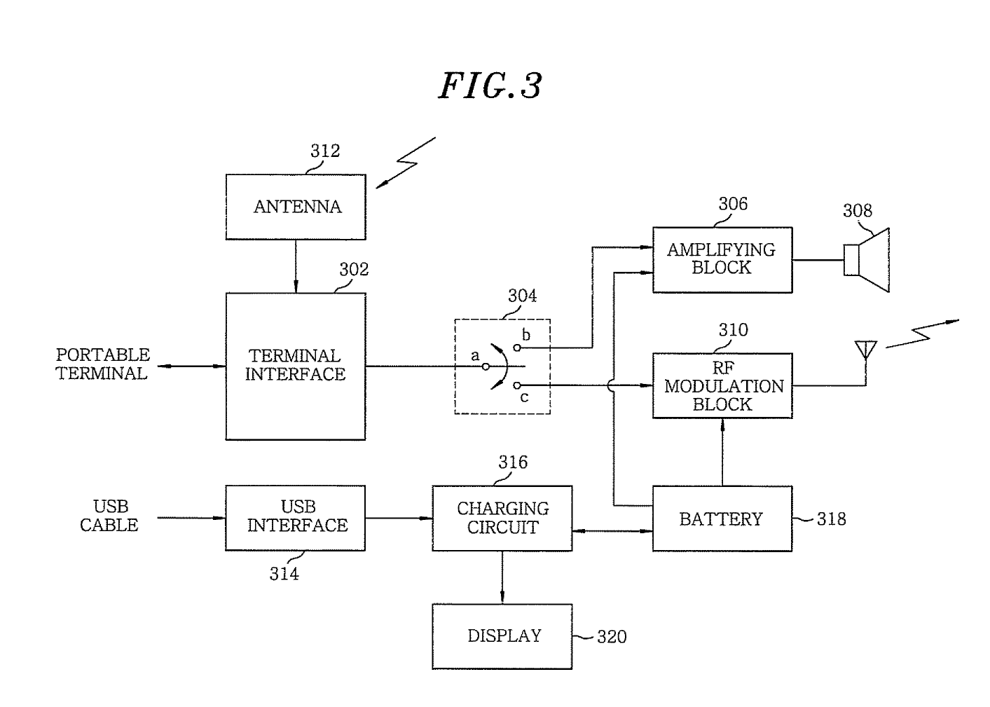

FIG. 3 illustrates a block diagram of an attachable speaker apparatus in accordance with the present invention. The attachable speaker apparatus includes a terminal interface 302, a switching block 304, an amplifying block 306, a speaker 308, an RF modulation block 310, an antenna 312, a USB interface 314, a charging circuit 316, a rechargeable battery 318, and a display 320.

Referring to FIG. 3, the terminal interface 302 performs the function of interfacing an audio signal (or voice signal) reproduced and provided from the portable terminal 110 through the connection plug 122 and the earphone jack 116 both and transmitting the audio signal to the switching block 304 having a fixed contact ‘a’ and moving contacts ‘b’ and ‘c’.

Although not shown in FIGS. 1 and 2, the switching block 304 is linked to an operating switch (not shown) which may be installed at an outer portion of the attachable speaker apparatus 120.

Further, the switching block 304 provides the user with an option of manually connecting contacts ‘a’ and ‘b’ or contacts ‘a’ and ‘c’ depending on the user's preference. That is, when the user operates the operating switch in order to use the attachable speaker apparatus 120 as an external speaker, the contacts ‘a’ and ‘b’ are connected. The term of ‘an external speaker’ refers that the attachable speaker apparatus 120 serves only to output an audio signal reproduced from the portable terminal 120 so that users can listen to music or the like without using an earphone.

On the other hand, when the user operates the operating switch in order to use the attachable speaker apparatus 120 as an audio wireless transmitter, the contacts ‘a’ and ‘c’ are connected. The term of ‘an audio wireless transmitter’ refers that the attachable speaker apparatus 120 serves to wirelessly transmit an audio signal in the form of a RF signal to an external speaker system, e.g., provided with a surround speaker so that users can spectacularly listen to music or the like without using an earphone.

Next, when the attachable speaker apparatus 120 functions as the external speaker depending on the user's selection, the amplifying block 306 provides the function of amplifying an audio or voice signal provided from the portable terminal 110 and provided through the contacts ‘a’ and ‘b’ of the switching block 304 to a preset level and delivering the same to the speaker 308. Therefore, the user is able to listen to the audio or voice provided through the speaker 308. Although the reference numerals are made different, the speaker 308 represents substantially the same component as the speaker 121 as shown in FIG. 1.

That is, the attachable speaker apparatus 120 realizes the external speaker function by the components including the terminal interface 302 the contacts ‘a’ and ‘b’ of the switching block 304, the amplifying block 306, and the speaker 308.

Further, when the attachable speaker apparatus 120 functions as the audio wireless transmitter depending on the user's selection, the RF modulation block 310 modulates an audio or voice signal provided from the portable terminal 110 and then provided through the contacts ‘a’ and ‘c’ of the switching block 304 into a RF signal. The RF signal so modulated is wirelessly transmitted to an external speaker equipment(for example, a speaker of home A/V system, a speaker of vehicle A/V system, etch, which are capable of wirelessly receiving the RF signal.) at a remote place. The external speaker equipment at the remote place demodulates the received RF signal into an original audio signal before modulation and then outputs the same through its own speaker.

As a result, the user is able to listen to the music or radio channel broadcast played by the portable terminal 110 through the speaker equipment of the A/V system, rather than through the attachable speaker apparatus 120.

In other words, the attachable speaker apparatus 120 can realize the function of transmitting audio signal to the outside by its components including the terminal interface 302, the contacts ‘a’ and ‘c’ of the switching block 304, and the RF modulation block 310. By this, various service needs of users can be effectively satisfied.

Thus, the attachable speaker apparatus 120 can be served as the external speaker or the audio wireless transmitter depending on switching result of the switching block which operates in response to the user's preference.

Meanwhile, although the attachable speaker apparatus has been described with respect to a case where the switching operation of the switching block 304, i.e., the function as an external speaker and the function as an audio wireless transmitter, is realized by the user's manual operation, this is only for illustration and the attachable speaker apparatus is not limited thereto. Alternatively, it is possible to design that the portable terminal may incur the switching operation of the switching block. That is, when the user switches or selects the mode (i.e., a functional mode as an external speaker or a functional mode as an audio wireless transmitter) in the portable terminal through its operating panel, the portable terminal is designed to generate its corresponding switching control signal and provides it to the terminal interface 302, where the terminal interface 302 automatically switches the contacts of the switching block 304 in response to the switching control signal, thereby further improving the convenience of selection operation of the users. Next, the antenna 312 is an antenna that receives a radio broadcast (for example, FM or AM radio broadcast), and the radio broadcast is transmitted to a radio reception block (not shown) of the portable terminal 110 through the terminal interface 302. Further, the antenna 312 serves to transmit the RF signal converted by the RF modulation block 310 to the external speaker equipment.

Therefore, with the attachable speaker apparatus 120 being connected to the portable terminal 110 through the connection plug 122, when the user selects the radio function, the attachable speaker apparatus 120 functions as a radio reception antenna for receiving a radio broadcast through the antenna 312.

Accordingly, the user is able to listen to high sensitivity radio broadcast without inserting an earphone (not shown) that functions as an antenna into the earphone jack 116 of the portable terminal 110.

Next, the USB interface 314 provides the function of interfacing electrical power for battery charging from an external power source when a USB cable (not shown) is inserted between the connection jack 126 and the external power source, and delivering the same to a charging circuit 316.

The charging circuit 316 charges a battery 318 through the electrical power provided from the external power source via the USB interface 314. The charging circuit 316 provides the function of generating a display control signal so that the user can visually recognize the charging of the battery 318 Further, the charging circuit 316 provides the same to a display, thereby operating (for example, yellow lighting) the display 320. The charging circuit 316 also cuts off the charging of the battery 318 with current by recognizing the completion of the charging of the battery 318, and at the same time generates a display control signal and provides it to the display (for example, a green light) to allow the user to visually recognize the completion of the charging of the battery 318

The rechargeable battery 318 supplies the electrical power to the components such as the amplifying block 306, the RF modulation block 310, etc. Such a battery 318 may include, for example, a rechargeable lithium polymer battery, and the display 320 may include, for example, an LED. Although the reference numerals are made different, the display 320 represents substantially the same component as the display 128 as shown in FIG. 1.

That is, the attachable speaker apparatus 120 in accordance with the present invention can realize the charging function with the components including the USB interface 314, the charging circuit 316, the battery 318, and the display 320. By using these components, the use of an environment-unfriendly disposable (or consumable) battery can be effectively suppressed.

Thus, the attachable speaker apparatus in accordance with the present invention can effectively satisfy various service needs of users, as well as realizing an environment-friendly attachable speaker apparatus by integrally realizing the functions of an external speaker, a wireless transmitter of an audio output for a portable terminal which can output sound through a speaker equipment at a remote place, an antenna for receiving a radio broadcast, and an automatic charging function and so on.

As described above, in accordance with the present invention, diversification of the functions of an attachable speaker apparatus can be realized by embedding the function of modulating an audio signal outputted from a portable terminal into a wirelessly transmittable signal and wirelessly transmitting it to a speaker system at a remote place and selectively performing an external speaker function and an audio wireless transmission function by a simple switching operation, thereby effectively satisfying various service needs of users, unlike the conventional attachable speaker that provides only the function as the external speaker for outputting the audio signal outputted from the portable terminal to the outside.

Further, the present invention can realize the reception of a high sensitivity radio broadcast even when an earphone functioning as a radio reception antenna is not inserted by embedding an antenna that is capable of receiving a radio broadcast. Moreover, the present invention can suppress the use of an environment-unfriendly consumable battery by employing a chargeable battery.

While the invention has been shown and described with respect to the embodiments, it will be understood by those skilled in the art that various changes and modification may be made without departing from the scope of the invention as defined in the following claims.

What is claimed is:

1. A speaker apparatus for use with a portable terminal having an audio reproducing capability, comprising:
a speaker;
a connection plug detachably and electrically connected to an earphone jack of the portable terminal;
an amplifying block for amplifying an audio signal to output the amplified audio signal through the speaker, the audio signal being delivered from the portable terminal through the connection plug connected to the earphone jack;
a RF modulation block for modulating the audio signal into an RF signal;
a switching block for selectively switching the audio signal to either the amplifying block or the RF modulation block.

2. The speaker apparatus of claim 1, further comprising:
an antenna for receiving a wireless aerial radio signal, wherein the received radio signal is provided through the connection plug to the portable terminal in order for processing thereof.

3. The speaker apparatus of claim 1, further comprising:
a rechargeable battery for supplying electrical power to the amplifying block and the RF modulation block;
an USE interface electrically connectable to an external power source; and
a charging circuit for charging the rechargeable battery with an electrical power provided through the USE interface from the external power source.

4. The speaker apparatus of claim 1, wherein the switching block is switched according to user's preference.

5. The speaker apparatus of claim 1, wherein the connection plug is a foldable connection plug where it is housed in a housing space formed at an outer surface of the attachable speaker.

6. The speaker apparatus of claim 1, further comprising:
an antenna for transmitting the RF signal to an external speaker equipment.

7. The speaker apparatus of claim 6, wherein the speaker equipment is one of an A/V system capable of wirelessly receiving the REF signal.

8. The speaker apparatus of claim 1, wherein the portable terminal includes an MP3 player, a portable phone, a PDA, a PMP, a DMB phone, or a DMB receiver

9. An audio reproducing apparatus comprising:
a portable terminal having capabilities of audio reproduction and radio processing; and
an attachable speaker apparatus optionally being connected to the portable terminal to produce an audio signal originated from the portable terminal, wherein the attachable speaker apparatus comprises:
a speaker;
a connection plug detachably and electrically connected to an earphone jack equipped in the portable terminal;
an amplifying block for amplifying the audio signal to generate an amplified audio signal through the speaker;
a RF modulation block for modulating the audio signal into an RF signal; and
a switching block for selectively relaying the audio signal to either the amplifying block or the RF modulation block.

10. The audio reproducing apparatus of claim 9, further comprising:
an antenna for receiving a wireless aerial radio signal, wherein the received radio signal is provided through the connection plug to the portable terminal in order for processing thereof.

11. The audio reproducing apparatus of claim 9, further comprising:
a rechargeable battery for supplying electrical power to the amplifying block and the RF modulation block;
a USB interface electrically connectable to an external power source; and
a charging circuit for charging the rechargeable battery with an electrical power provided through the USB interface.

12. The audio reproducing apparatus of claim 9, further comprising:
an antenna for transmitting the RF signal to an external speaker equipment.

13. The audio reproducing apparatus of claim 12, wherein the speaker equipment is one of an A/V system capable of wirelessly receiving the RF signal.

14. The audio reproducing apparatus of claim 9, wherein the portable terminal includes an MP3 player, a portable phone, a PDA, a PMP, a DMB phone, or a DMB receiver.
